(19) United States
(12) Patent Application Publication
(10) Pub. No.: US 2025/0192596 A1
(43) Pub. Date: Jun. 12, 2025

(54) CHARGER CONTROL METHOD AND APPARATUS, AND CHARGER AND VEHICLE

(71) Applicant: BYD COMPANY LIMITED, SHENZHEN (CN)

(72) Inventors: Chao WANG, Shenzhen (CN); Weidong LIU, Shenzhen (CN); Xinghui WANG, Shenzhen (CN)

(21) Appl. No.: 19/059,042

(22) Filed: Feb. 20, 2025

Related U.S. Application Data
(63) Continuation of application No. PCT/CN2023/108247, filed on Jul. 19, 2023.

(30) Foreign Application Priority Data
Aug. 30, 2022 (CN) 202211049272.1

(51) Int. Cl. H02J 7/04; B60R 16/023; B60R 16/033; H02M 1/42; H02M 3/00; H02M 3/335

(52) U.S. Cl. CPC H02J 7/04; B60R 16/0231; B60R 16/033; H02M 1/4233; H02M 3/01; H02M 3/33573; H02J 2207/20

(57) ABSTRACT

A method for controlling a charger, includes: determining a target current value on an alternating-current side, according to a present voltage and a steady-state target current on the alternating-current side of the charger; calibrating the target current value by a current calibration amount on the alternating-current side to obtain a calibrated target current value; and controlling a current on the alternating-current side, according to the calibrated target current value, the present voltage, a present current on the alternating-current side, and a voltage of a bus capacitor, to follow the calibrated target current value. The charger comprises an on-board charger or a charging pile charger.

### CROSS-REFERENCE TO RELATED APPLICATIONS

This application is a continuation application of International Patent Application No. PCT/CN2023/108247, filed on Jul. 19, 2023, which is based on and claims priority to and benefits of Chinese Patent Application No. 202211049272.1, filed on Aug. 30, 2022. The entire content of all of the above-referenced applications is incorporated herein by reference.

### FIELD

The present disclosure relates to the field of vehicle technologies, and particularly, to a charger control method and apparatus, a charger, and a vehicle.

### BACKGROUND

An on-board charger is an electronic device converting an alternating-current into a direct-current and is used as an on-board charging device of an electric vehicle to supply power to a battery. A two-stage topological structure is usually used in existing on-board chargers, where a pre-stage circuit is a power factor calibration circuit, and a post-stage circuit is an isolated DCDC circuit (that is, an LCC circuit (resonant circuit)), and an instantaneous power difference between an alternating-current side and a direct-current side is balanced through a bus capacitor between the two-stage circuits.

The on-board charger performs charging control according to a sampled voltage and a sampled current on the alternating-current side that are collected by a sampling circuit on the alternating-current side. However, due to existence of a hardware sampling error in the sampling circuit, a deviation may occur between a current of a positive half cycle and a current of a negative half cycle on the alternating-current side, that is, an alternating-current may be unbalanced.

### SUMMARY

To overcome problems existing in the related art, the present disclosure provides a charger control method and apparatus, a charger, and a vehicle.

According to a first aspect, the present disclosure provides a charger control method. The method is applicable to a charger, and the charger is an on-board charger or a charging pile charger. The method includes:
determining a target current value on an alternating-current side according to a present voltage and a steady-state target current on the alternating-current side of the charger;
calibrating the target current value by a current calibration amount on the alternating-current side to obtain a calibrated target current value; and
controlling a current on the alternating-current side according to a calibrated target current value, the present voltage, a present current on the alternating-current side, and a voltage of a bus capacitor, to follow the calibrated target current value.

In an embodiment, the current calibration amount on the alternating-current side is determined in the following manner:
collecting currents of a first quantity on the alternating-current side according to a first sampling periodicity; and
determining the current calibration amount on the alternating-current side according to the currents of the first quantity on the alternating-current side.

In an embodiment, the determining the current calibration amount on the alternating-current side according to the currents of the first quantity on the alternating-current side includes:
determining an average value of the currents of the first quantity on the alternating-current side as the current calibration amount on the alternating-current side.

In an embodiment, the first quantity is an integer multiple of a quotient of a current periodicity on the alternating-current side and the first sampling periodicity, where the first sampling periodicity is less than the current periodicity on the alternating-current side.

In an embodiment, the present voltage and the present current on the alternating-current side of the charger are obtained by:

determining the present voltage on the alternating-current side according to an AD value of the present voltage on the alternating-current side of the charger collected by a sampling circuit on the alternating-current side, and determining the present current on the alternating-current side according to an AD value of the present voltage on the alternating-current side collected by the sampling circuit on the alternating-current side; and
the method further includes:
performing zero-point calibration on the sampling circuit on the alternating-current side when the charger is powered on.

In an embodiment, the performing zero-point calibration on the sampling circuit on the alternating-current side includes:
calibrating an AD value of a sampled voltage and/or an AD value of a sampled current of the sampling circuit on the alternating-current side.

In an embodiment, the calibrating an AD value of the sampled voltage and/or an AD value of the sampled current of the sampling circuit on the alternating-current side includes:
collecting AD values of voltages of a second quantity and/or AD values of currents of the second quantity on the alternating-current side according to a second sampling periodicity;
determining a calibration amount of the AD value of the sampled voltage of the sampling circuit on the alternating-current side according to the AD values of the voltages of the second quantity on the alternating-current side, and/or determining a calibration amount of the AD value of the sampled current of the sampling circuit on the alternating-current side according to the AD values of the currents of the second quantity on the alternating-current side; and
calibrating the AD value of the sampled voltage according to the calibration amount of the AD value of the sampled voltage, and/or calibrating the AD value of the sampled current according to the calibration amount of the AD value of the sampled current.

According to a second aspect, the present disclosure provides a charger control apparatus. The charger control apparatus includes:
a memory storing a computer program; and
a controller configured to execute the computer program, implementing the steps of the charger control method according to the first aspect of the present disclosure.

According to a third aspect, the present disclosure provides a charger. The charger includes a power factor calibration circuit, a bus capacitor, and an LLC circuit that are connected to each other. The charger further includes:
the charger control apparatus according to the second aspect of the present disclosure, where the charger control apparatus is connected to the power factor calibration circuit and the LLC circuit.

According to a fourth aspect, the present disclosure provides a vehicle, including a battery and the charger according to the third aspect of the present disclosure.

In the foregoing technical solutions, the target current value on the alternating-current side is determined according to the present voltage and the steady-state target current on the alternating-current side of the charger; the target current value is then calibrated by using the current calibration amount; and the current on the alternating-current side is finally controlled according to the calibrated target current value, the present voltage on the alternating-current side, the present current on the alternating-current side, and the voltage of the bus capacitor, to cause the current on the alternating-current side to follow the calibrated target current value, thereby implementing power factor calibration. The target current value is calibrated by using the current calibration amount, so that the accuracy of the calibrated target current value can be ensured, and the current on the alternating-current side can closely follow the calibrated target current value, thereby avoiding a deviation from occurring between a current of a positive half cycle and a current of a negative half cycle on the alternating-current side, and achieving a final objective of adjusting a degree of balance of an actual current on the alternating-current side, that is, achieving dynamic balance of an alternating-current.

Other features and advantages of the present disclosure will be described in detail in the following implementations.

### BRIEF DESCRIPTION OF THE DRAWINGS

The accompanying drawings are provided to further understand the present disclosure, and they constitute a part of the specification. The accompanying drawings, along with the implementations, are used to explain the present disclosure, and constitute no limitation on the present disclosure. In the accompanying drawings:

FIG. 1 is a structural block diagram of a charger according to an embodiment of the present disclosure.

FIG. 2 is a diagram of a circuit topology structure of a charger according to an embodiment of the present disclosure.

FIG. 3 is a flowchart of a charger control method according to an embodiment of the present disclosure.

FIG. 4 is a schematic diagram of a charger control method according to an embodiment of the present disclosure.

### DETAILED DESCRIPTION

The following describes the implementations of the present disclosure in detail with reference to the accompanying drawings. It should be understood that the implementations described herein are merely used to describe and explain the present disclosure, but are not to limit the present disclosure.

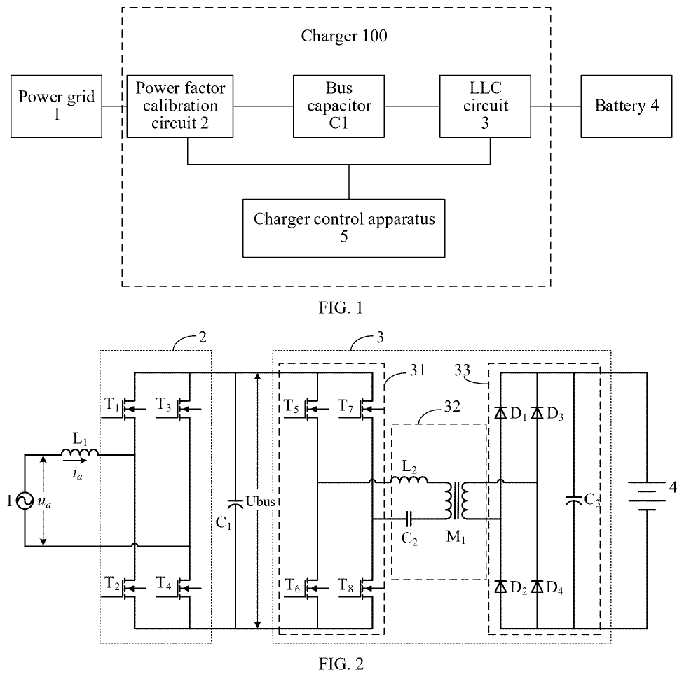

The present disclosure provides a charger. The charger may be an on-board charger or a charging pile charger, and the charging pile charger and the on-board charger may adopt a same circuit topology structure (as shown in FIG. 2). As shown in FIG. 1, the charger 100 includes a charger control apparatus 5, and a power factor calibration circuit 2, a bus capacitor C1, and an LLC circuit 3 that are connected sequentially. The power factor calibration circuit 2 is connected to a power grid 1, the LLC circuit 3 is configured to be connected to a battery 4, and the bus capacitor C1 may be an electrolytic capacitor, a film capacitor, a ceramic capacitor, or the like, and configured to filter a direct voltage.

The charger control apparatus 5 is connected to the power factor calibration circuit 2 and the LLC circuit 3 separately, and is configured to perform a charger control method applicable to the charger and to control the power factor calibration circuit 2 and the LLC circuit 3 to work, so as to charge the battery. The power factor calibration circuit 2 is configured to perform power factor calibration on an input signal of the power grid and output a current signal obtained through the power factor calibration. The LLC circuit 3 is configured to perform direct-current conversion on the current signal obtained through the power factor calibration, and to obtain a direct-current to charge the battery of a vehicle.

As shown in FIG. 2, the power factor calibration circuit 2 may include: a third-phase bridge arm formed by a first transistor T1 and a second transistor T2, and a fourth-phase bridge arm formed by a third transistor T3 and a fourth transistor T4, where a midpoint of the third-phase bridge arm is connected to a positive electrode of the power grid 1 through an inductor L1, and a midpoint of the fourth-phase bridge arm is connected to a negative electrode of the power grid 1. A third bus end of the third-phase bridge arm and the fourth-phase bridge arm are connected to an end of the bus capacitor C1, and a fourth bus end of the third-phase bridge arm and the fourth-phase bridge arm are connected to another end of the bus capacitor C1.

A present voltage on an alternating-current side of the charger is uₐ, a present current on the alternating-current side of the charger is iₐ, and a voltage of the bus capacitor is Ubus.

As shown in FIG. 2, the LLC circuit 3 includes an inverter circuit 31, a resonant circuit 32, and a rectifier circuit 33 that are connected sequentially.

The inverter circuit 31 includes: a first-phase bridge arm formed by a fifth transistor T5 and a sixth transistor T6, and a second-phase bridge arm formed by a seventh transistor T7 and an eighth transistor T8, where a first bus end of the first-phase bridge arm and the second-phase bridge arm is connected to the end of the bus capacitor C1 and the third bus end separately, and a second bus end of the first-phase bridge arm and the second-phase bridge arm is connected to the another end of the bus capacitor C1 and the fourth bus end separately.

The resonant circuit 32 adopts an LLC resonant cavity, and includes a resonant inductor L2, a resonant capacitor C2, and a transformer M1. An end of the resonant inductor L2 is connected to a midpoint of the first-phase bridge arm, and another end is connected to a first input end on a primary side of the transformer M1, where the resonant inductor L2 may be magnetically integrated with the transformer M1 to participate in resonance in the resonant circuit. An end of the resonant capacitor C2 is connected to a midpoint of the second-phase bridge arm, and another end is connected to a second input end on the primary side of the transformer M1, where the resonant capacitor C2 may be a film capacitor or a ceramic capacitor, to prevent a direct-current offset of the transformer M1 and participate in resonance in the resonant circuit. The transformer M1 may be a tapped transformer and configured for electric energy isolation transmission.

The rectifier circuit 33 includes a fifth-phase bridge arm formed by a first diode D1 and a second diode D2, a sixth-phase bridge arm formed by a third diode D3 and a fourth diode D4, and a filter capacitor C3. A midpoint of the fifth-phase bridge arm is connected to a first input end on a secondary side of the transformer M1, and a midpoint of the sixth-phase bridge arm is connected to a second input end on the secondary side of the transformer M1. A fifth bus end of the fifth-phase bridge arm and the sixth-phase bridge arm is connected to an end of the filter capacitor C3 and the positive electrode of the battery 4 separately, and a sixth bus end of the fifth-phase bridge arm and the sixth-phase bridge arm is connected to another end of the filter capacitor C3 and the negative electrode of the battery 4 separately. The filter capacitor C3 is a capacitor on a battery side and is configured to filter a direct voltage on the battery side.

In addition, it should be noted that, the rectifier circuit 33 may use a transistor device or a rectifier diode (as shown in FIG. 2) to implement electric energy transmission.

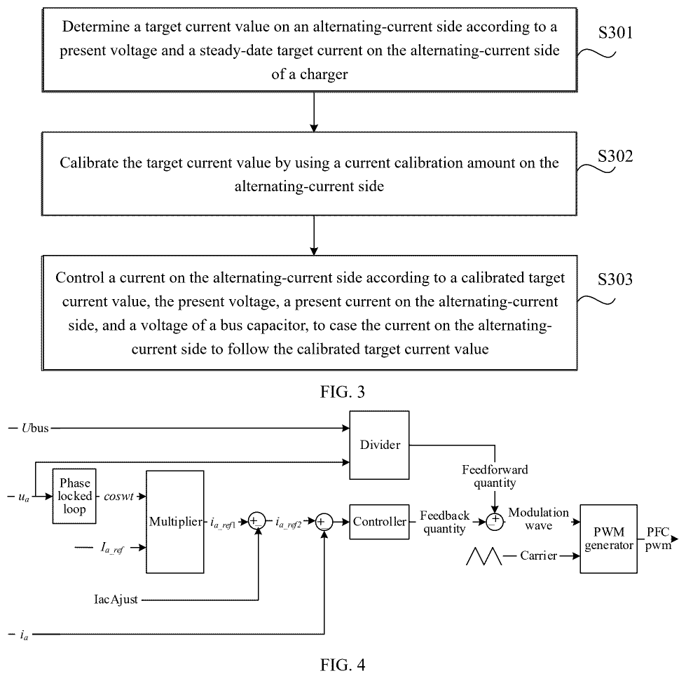

The following describes the charger control method applicable to the charger in detail. As shown in FIG. 3, the method may include S301 to S303.

S301: A target current value on an alternating-current side is determined according to a present voltage and a steady-state target current on the alternating-current side of the charger.

In the present disclosure, the present voltage on the alternating-current side may be determined according to a present voltage analog to digital (AD) value on the alternating-current side of the charger collected by a sampling circuit on the alternating-current side. The AD value (analog to digital value) of the voltage is a corresponding digital signal value obtained through conversion by an analog to digital converter (ADC).

In an implementation, a present voltage corresponding to the AD value of the present voltage may be determined according to a conversion relationship between voltages on the alternating-current side and AD values of the voltage.

For example, the voltage on the alternating-current side is equal to a sum of b1 and a product of k1 and the AD value of the voltage on the alternating-current side.

In addition, the steady-state target current is a current value corresponding to the alternating-current side of the charger when the charger is in a stable and efficient optimal working state.

In an embodiment, a phase of an alternating-current outputted by the power grid may be extracted according to the present voltage uₐ (that is, a voltage of the current outputted by the power grid). For example, a product of the steady-state target current and the phase of the alternating-current outputted by the power grid may be determined as the target current value. As shown in FIG. 4, if the steady-state target current is I_{a_ref}, and the phase of the alternating-current outputted by the power grid and determined based on a phase locked loop is cos wt, I_{a_ref}*cos wt may be determined as the target current value I_{a_ref1}.

S302: The target current value is calibrated by using a current calibration amount on the alternating-current side.

For example, as shown in FIG. 4, a difference between the target current value I_{a_ref1} and the current calibration amount IacAjust may be determined as a calibrated target current value I_{a_ref2}.

S303: A current on the alternating-current side is controlled according to a calibrated target current value, the present voltage, a present current on the alternating-current side, and a voltage of a bus capacitor, to cause the current on the alternating-current side to follow the calibrated target current value.

In the present disclosure, the present current on the alternating-current side may be determined according to a present current analog to digital (AD) value on the alternating-current side collected by the sampling circuit on the alternating-current side.

In an implementation, a present current corresponding to the AD value of the present current may be determined according to a conversion relationship between currents on the alternating-current side and AD values of the current, where the AD value of the current is a digital signal value obtained through conversion by the ADC.

For example, the current on the alternating-current side is equal to a sum of b2 and a product of k2 and the AD value of the current on the alternating-current side.

In an embodiment, as shown in FIG. 4, the voltage Ubus of the bus capacitor and the present voltage uₐ may be inputted into a divider, to obtain a feedforward quantity uₐ/Ubus of a closed-loop control result. The calibrated target current value I_{a_ref2} and the present current iₐ are inputted into a controller, to obtain a feedback quantity of the closed-loop control result. Then, a difference between the feedforward quantity and the feedback quantity is used as a modulation wave and transmitted together with a carrier to a Pulse-width modulation (PWM) generator, to obtain a duty cycle of the power factor calibration (PFC) circuit, and the current on the alternating-current side may follow the calibrated target current value in a manner of adjusting the duty cycle of the power factor calibration circuit, to implement power factor calibration.

In the foregoing technical solutions, the target current value on the alternating-current side is determined according to the present voltage and the steady-state target current on the alternating-current side of the charger; the target current value is then calibrated by using the current calibration amount; and the current on the alternating-current side is finally controlled according to the calibrated target current value, the present voltage on the alternating-current side, the present current on the alternating-current side, and the voltage of the bus capacitor, to cause the current on the alternating-current side to follow the calibrated target current value, thereby implementing power factor calibration. The target current value is calibrated by using the current calibration amount, so that the accuracy of the calibrated target current value can be ensured, and the current on the alternating-current side can closely follow the calibrated target current value, thereby avoiding a deviation from occurring between a current of a positive half cycle and a current of a negative half cycle on the alternating-current side, and achieving a final objective of adjusting a degree of balance of an actual current on the alternating-current side, that is, achieving dynamic balance of an alternating-current.

The following describes in detail a manner of determining the steady-state target current on the alternating-current side. In an embodiment, the step may be implemented through the following step (1) and step (2).

(1) A target charging power on the alternating-current side is determined.

In the present disclosure, the target charging power is a power on the alternating-current side of the charger when the charger is in a stable and efficient optimal working state. In an embodiment, a minimum value in a maximum output power of the power grid, a current output power of the power grid, a maximum charging power of the battery allowed by a battery management system, a maximum power allowed by a wire, and a maximum charging power of the charger is determined as the target charging power.

For example, the maximum output power of the power grid and the maximum power allowed by the wire may be determined according to content in the national standard GBT 18487.1-2015; the current output power of the power grid may be determined through a power sensor arranged on the power grid in advance; the maximum charging power of the battery allowed by the battery management system may be determined according to related parameter information of the battery; and the maximum charging power of the charger may be determined according to hardware device selection of the charger, that is, belong to an inherent attribute parameter of the charger. The to-be-selected powers are respectively maximum powers corresponding to the power grid, the battery, the wire, and the charger, and the current output power of the power grid. Therefore, by selecting a minimum value as the target charging power, it may be ensured that during working of the charger, the power grid and the battery connected to the charger and wires connecting various parts are all in a safe working state, thereby reducing a possibility of a damaged electronic element on a related circuit. In addition, the power on the alternating-current side of the charger may be ensured to reach a maximum value while working safety is ensured. Therefore, if the power on the alternating-current side of the charger is the target charging power, the charger may be in the stable and efficient optimal working state.

(2) The steady-state target current on the alternating-current side is determined according to the target charging power.

In the present disclosure, the steady-state target current on the alternating-current side is a current value determined according to the target charging power. The steady-state target current may be determined according to a quotient of the target charging power and a valid value of an alternating-current voltage outputted by the power grid.

The following describes in detail a manner of determining the current calibration amount on the alternating-current side. In an embodiment, the step may be implemented through the following step [1] and step [2].

[1] currents of a first preset quantity on the alternating-current side are consecutively collected according to a first sampling periodicity.

In the present disclosure, the first preset quantity may be any set value, for example, 100, or may be an integer multiple of a quotient of a current periodicity on the alternating-current side and the first sampling periodicity, where the first sampling periodicity is far less than the current periodicity on the alternating-current side.

[2] The current calibration amount on the alternating-current side is determined according to the currents of the first preset quantity on the alternating-current side.

In an implementation, an average value of the currents of the first preset quantity on the alternating-current side may be determined as the current calibration amount on the alternating-current side.

In addition, from the analysis according to a principle of the sampling circuit on the alternating-current side, key factors affecting sampling include a resistance value of a dividing resistor of the sampling circuit and power supply of a sampling Hall or an operational amplifier. The difference in the resistance value of the dividing resistor can be made up by calibration of a sampling formula, but an output characteristic of the Hall or the operational amplifier may be affected due to board-level power supply. The alternating-current voltage and the current are alternating-current values, so that zero-point crossing detection is very important. If a power supply voltage deviates, a sampling zero-point reference deviates, leading to a control error and a deviation between a current of a positive half cycle and a current of a negative half cycle, resulting in an unbalanced alternating-current.

Therefore, to further improve dynamic balance of the alternating-current, in addition to calibrating the target current value in the working process of the charger, zero-point calibration may be further performed on the sampling circuit on the alternating-current side before the charger starts to work, to avoid a zero-point deviation caused by an unstable voltage, thereby improving the dynamic balance of the alternating-current. In an embodiment, the method may further include the following steps:
zero-point calibration is performed on the sampling circuit on the alternating-current side when the charger is powered on.

In the present disclosure, the charger includes three processes, namely, power-on, working, and power-off. An alternating-current voltage (that is, the power grid) is connected to the charger to power on the charger, and the charger is powered off when the alternating-current voltage is cut off, and a process in which the charger charges a battery of a vehicle is the working process.

In an embodiment, zero-point calibration may be performed on the sampling circuit on the alternating-current side in a plurality of manners.

In an implementation, an AD value of the sampled voltage of the sampling circuit on the alternating-current side is calibrated to implement zero-point calibration on the sampling circuit on the alternating-current side.

In an embodiment, AD values of the voltages of a second preset quantity on the alternating-current side may be consecutively collected according to a second sampling periodicity; a calibration amount of the AD value of the sampled voltage of the sampling circuit on the alternating-current side is then determined according to AD values of the voltages of the second preset quantity of on the alternating-current side; and the AD value of the sampled voltage is finally calibrated according to the calibration amount of the AD value of the sampled voltage.

The second preset quantity may be any set value, for example, 100, or may be an integer multiple of a quotient of the current periodicity on the alternating-current side and the second sampling periodicity, where the second sampling periodicity is far less than the current periodicity on the alternating-current side.

For example, an average value of the AD values of the voltages of the second preset quantity on the alternating-current side may be determined as the calibration amount of the AD value of the sampled voltage of the sampling circuit on the alternating-current side; and a difference between the AD value of the sampled voltage and the calibration amount of the AD value of the sampled voltage is determined as a calibrated AD value of the sampled voltage.

In another implementation, an AD value of a sampled current of the sampling circuit on the alternating-current side is calibrated to implement zero-point calibration on the sampling circuit on the alternating-current side.

In an embodiment, AD values of the currents of a second preset quantity on the alternating-current side may be consecutively collected according to a second sampling periodicity; a calibration amount of the AD value of the sampled current of the sampling circuit on the alternating-current side is then determined according to AD values of currents of the second preset quantity on the alternating-current side; and the AD value of the sampled current is finally calibrated according to the calibration amount of the AD value of the sampled current.

For example, an average value of AD values of currents of the second preset quantity on the alternating-current side may be determined as the calibration amount of the AD value of the sampled current of the sampling circuit on the alternating-current side; and a difference between the AD value of the sampled current and the calibration amount of the AD value of the sampled current is determined as a calibrated AD value of the sampled current.

In another implementation, an AD value of a sampled voltage and an AD value of a sampled current of the sampling circuit on the alternating-current side are calibrated to implement zero-point calibration on the sampling circuit on the alternating-current side.

In an embodiment, AD values of voltages of a second preset quantity and AD values of currents of a second preset quantity on the alternating-current side may be consecutively collected according to a second sampling periodicity; a calibration amount of the AD value of the sampled voltage of the sampling circuit on the alternating-current side is determined according to AD values of the voltages of the second preset quantity on the alternating-current side, and a calibration amount of the AD value of the sampled current of the sampling circuit on the alternating-current side is determined according to AD values of currents of the second preset quantity on the alternating-current side; and the AD value of the sampled voltage is finally calibrated according to the calibration amount of the AD value of the sampled voltage, and the AD value of the sampled current is calibrated according to the calibration amount of the AD value of the sampled current.

In addition, the charger control apparatus 5 may include:
a memory, having a computer program stored therein; and
a controller, when executing the computer program, implementing the steps of the charger control method according to the present disclosure.

The present disclosure further provides a vehicle, including the charger according to the present disclosure.

Examples of implementations of the present disclosure are described in detail above with reference to the accompanying drawings, but the present disclosure is not limited to the details in the above implementations. Various variations may be made to the technical solutions of the present disclosure within the scope of the technical idea of the present disclosure, and such variations shall all fall within the protection scope of the present disclosure.

In addition, it should be noted that, technical features described in the foregoing implementations may be combined in any appropriate manner without conflict. To avoid unnecessary repetition, various possible combinations are not further described in the present disclosure.

In addition, the various implementations of the present disclosure may be combined arbitrarily without departing from the idea of the present disclosure, and such combinations shall also be considered as the content disclosed in the present disclosure.

What is claimed is:

1. A method for controlling a charger, comprising:
determining a target current value on an alternating-current side, according to a present voltage and a steady-state target current on the alternating-current side of the charger;
calibrating the target current value by a current calibration amount on the alternating-current side to obtain a calibrated target current value; and
controlling a current on the alternating-current side, according to the calibrated target current value, the present voltage, a present current on the alternating-current side, and a voltage of a bus capacitor, to follow the calibrated target current value,
wherein the charger comprises an on-board charger or a charging pile charger.

2. The method according to claim 1, wherein the current calibration amount on the alternating-current side is determined by:
collecting currents of a first quantity on the alternating-current side according to a first sampling periodicity; and
determining the current calibration amount on the alternating-current side according to the currents of the first quantity on the alternating-current side.

3. The method according to claim 2, wherein the determining the current calibration amount on the alternating-current side according to the currents of the first quantity on the alternating-current side comprises:
determining an average value of the currents of the first quantity on the alternating-current side as the current calibration amount on the alternating-current side.

4. The method according to claim 2, wherein the first quantity is an integer multiple of a quotient of a current periodicity on the alternating-current side and the first sampling periodicity, wherein the first sampling periodicity is less than the current periodicity on the alternating-current side.

5. The method according to claim 1, wherein
the present voltage and the present current on the alternating-current side of the charger are obtained by:
determining the present voltage on the alternating-current side according to an AD value of the present voltage on the alternating-current side of the charger collected by a sampling circuit on the alternating-current side, and determining the present current on the alternating-current side according to an AD value of the present current on the alternating-current side collected by the sampling circuit on the alternating-current side; and
the method further comprises:
performing zero-point calibration on the sampling circuit on the alternating-current side when the charger is powered on.

6. The method according to claim 5, wherein the performing zero-point calibration on the sampling circuit on the alternating-current side comprises:
calibrating an AD value of a sampled voltage and/or an AD value of a sampled current of the sampling circuit on the alternating-current side.

7. The method according to claim 6, wherein the calibrating an AD value of the sampled voltage and/or an AD value of the sampled current of the sampling circuit on the alternating-current side comprises:
collecting AD values of voltages of a second quantity and/or AD values of currents of the second quantity on the alternating-current side according to a second sampling periodicity;
determining a calibration amount of the AD value of the sampled voltage of the sampling circuit on the alternating-current side according to the AD values of the voltages of the second quantity on the alternating-current side, and/or determining a calibration amount of the AD value of the sampled current of the sampling circuit on the alternating-current side according to the AD values of the currents of the second quantity on the alternating-current side; and
calibrating the AD value of the sampled voltage according to the calibration amount of the AD value of the sampled voltage, and/or calibrating the AD value of the sampled current according to the calibration amount of the AD value of the sampled current.

8. An apparatus for controlling a charger, comprising:
a memory storing a computer program; and
a controller, configured to execute the computer program to perform operations comprising:
determining a target current value on an alternating-current side, according to a present voltage and a steady-state target current on the alternating-current side of the charger;
calibrating the target current value by a current calibration amount on the alternating-current side to obtain a calibrated target current value; and
controlling a current on the alternating-current side, according to the calibrated target current value, the present voltage, a present current on the alternating-current side, and a voltage of a bus capacitor, to follow the calibrated target current value.

9. The apparatus according to claim 8, wherein the current calibration amount on the alternating-current side is determined by:
collecting currents of a first quantity on the alternating-current side according to a first sampling periodicity; and
determining the current calibration amount on the alternating-current side according to the currents of the first quantity on the alternating-current side.

10. The apparatus according to claim 9, wherein the determining the current calibration amount on the alternating-current side according to the currents of the first quantity on the alternating-current side comprises:
determining an average value of the currents of the first quantity on the alternating-current side as the current calibration amount on the alternating-current side.

11. The apparatus according to claim 9, wherein the first quantity is an integer multiple of a quotient of a current periodicity on the alternating-current side and the first sampling periodicity, wherein the first sampling periodicity is less than the current periodicity on the alternating-current side.

12. The apparatus according to claim 8, wherein
the present voltage and the present current on the alternating-current side of the charger are obtained by:
determining the present voltage on the alternating-current side according to an AD value of the present voltage on the alternating-current side of the charger collected by a sampling circuit on the alternating-current side, and determining the present current on the alternating-current side according to an AD value of the present current on the alternating-current side collected by the sampling circuit on the alternating-current side; and
the operations further comprise:
performing zero-point calibration on the sampling circuit on the alternating-current side when the charger is powered on.

13. The apparatus according to claim 12, wherein the performing zero-point calibration on the sampling circuit on the alternating-current side comprises:
calibrating an AD value of a sampled voltage and/or an AD value of a sampled current of the sampling circuit on the alternating-current side.

14. The apparatus according to claim 13, wherein the calibrating the AD value of the sampled voltage and/or the AD value of the sampled current of the sampling circuit on the alternating-current side comprises:
collecting AD values of voltages of a second quantity and/or AD values of currents of the second quantity on the alternating-current side according to a second sampling periodicity;
determining a calibration amount of the AD value of the sampled voltage of the sampling circuit on the alternating-current side according to the AD values of the voltages of the second quantity on the alternating-current side, and/or determining a calibration amount of the AD value of the sampled current of the sampling circuit on the alternating-current side according to the AD values of the currents of the second quantity on the alternating-current side; and
calibrating the AD value of the sampled voltage according to the calibration amount of the AD value of the sampled voltage, and/or calibrating the AD value of the sampled current according to the calibration amount of the AD value of the sampled current.

15. A charger, comprising a power factor calibration circuit, the bus capacitor, and an LLC circuit that are connected to each other, and the apparatus for controlling the charger according to claim 8, wherein the apparatus is connected to the power factor calibration circuit and the LLC circuit.

16. A vehicle, comprising a battery and a charger, wherein the charger comprises a power factor calibration circuit, a bus capacitor, and an LLC circuit that are connected to each other, and an apparatus for controlling the charger,
wherein the apparatus is connected to the power factor calibration circuit and the LLC circuit, and the apparatus comprises:
a memory storing a computer program; and
a controller, configured to execute the computer program to perform operations comprising:
determining a target current value on an alternating-current side, according to a present voltage and a steady-state target current on the alternating-current side of the charger;
calibrating the target current value by a current calibration amount on the alternating-current side to obtain a calibrated target current value; and
controlling a current on the alternating-current side, according to the calibrated target current value, the present voltage, a present current on the alternating-current side, and a voltage of the bus capacitor, to follow the calibrated target current value.

17. The vehicle according to claim 16, wherein the current calibration amount on the alternating-current side is determined by:
collecting currents of a first quantity on the alternating-current side according to a first sampling periodicity; and
determining the current calibration amount on the alternating-current side according to the currents of the first quantity on the alternating-current side.

18. The vehicle according to claim 17, wherein the determining the current calibration amount on the alternating-current side according to the currents of the first quantity on the alternating-current side comprises:
determining an average value of the currents of the first quantity on the alternating-current side as the current calibration amount on the alternating-current side.

19. The vehicle according to claim 17, wherein the first quantity is an integer multiple of a quotient of a current periodicity on the alternating-current side and the first sampling periodicity, wherein the first sampling periodicity is less than the current periodicity on the alternating-current side.

20. The vehicle according to claim 16, wherein
the present voltage and the present current on the alternating-current side of the charger are obtained by:
determining the present voltage on the alternating-current side according to an AD value of the present voltage on the alternating-current side of the charger collected by a sampling circuit on the alternating-current side, and determining the present current on the alternating-current side according to an AD value of the present current on the alternating-current side collected by the sampling circuit on the alternating-current side; and
the operations further comprise:
performing zero-point calibration on the sampling circuit on the alternating-current side when the charger is powered on.
